(19) United States
(12) Patent Application Publication
(10) Pub. No.: US 2012/0179956 A1
(43) Pub. Date: Jul. 12, 2012

(54) Structured domain specific language and grid valued machine for creating spreadsheets and numerical plans

(76) Inventor: Daniel Ben Winterstein, Edinburgh (GB)

(21) Appl. No.: 13/335,137

(22) Filed: Dec. 22, 2011

(30) Foreign Application Priority Data
Jan. 10, 2011 (GB) GB1100237.5

(51) Int. Cl. G06F 17/00

(52) U.S. Cl. 715/212

(57) ABSTRACT

The new invention is a system for specifying spreadsheets, business plans or other numerical plans using a structured text format, also known as a domain specific language (DSL), and a grid-valued machine. The DSL is both human-readable and can be interpreted by a computing system to create a spreadsheet or related outputs, including the calculation of business metrics. The grid-valued machine is a new model for a computer fitted to this purpose, where a grid of values is used as the underlying data model (i.e., as opposed to the normal register machine model). The language can include terms for describing uncertainty, allowing the specification and presentation of stochastic plans, e.g. for risk analysis. This can be supported in the grid-valued machine using a Monte Carlo approach with multiple grids.

### CROSS-REFERENCE TO RELATED APPLICATIONS

NA

### BACKGROUND OF THE INVENTION

1. Field of the Invention

The invention is in the field of business software, particularly software used for developing and presenting plans involving numerical elements, such as business plans.

2. Discussion of the State of the Art

Spreadsheets are well known, and there are many suppliers providing spreadsheet systems. Microsoft Excel™, Lotus 123™ and Google Docs™ are good examples of spreadsheet systems.

Spreadsheets are versatile, and can be used for many purposes. One such purpose is to present and reason about business plans, or other plans involving numerical quantities. The advantages of describing a plan using a spreadsheet include that the spreadsheet can be used to calculate various quantities of interest and to generate charts.

The inventor have observed that users encounter several problems when working with spreadsheets, both in creating spreadsheets, and in interpreting them.

In addition, there are tasks for which spreadsheets provide only moderate support for. These include describing plans that involve uncertainty.

There would be considerable benefit in a method and system for planning that had the advantages of using a spreadsheet, but was clearer and easier to use.

Domain Specific Languages are used in other areas of computing. Examples include the use of HTML and CSS to specify web content and layout, or the text formatting language Latex. There are several ways to develop software (called “parsers”) that can interpret a Domain Specific Language. These include using regular expressions, using parser combinators, or using a parser-generator with a language specification; these techniques are well known in the art.

A Domain Specific Language for expressing business plans and related numerical tasks could solve problems associated with spreadsheets.

Spreadsheets have a language for expressing the formulas inside a cell. However these formulas form a part of the spreadsheet and must be entered into the specific cells; the spreadsheet formula language does not allow the user to express the structure of the spreadsheet, and could not serve as an alternative to the spreadsheet.

An abstract machine provides a model for computing. One of the most commonly used is the Register Machine, where a set of registers are used like pigeon-holes to store the values of variables. Most modern computers are a form of Register Machine. Other notable abstract machines include: the Turing Machine, Finite State Machines, which are used for handling regular expressions, and the Java™ Virtual Machine. All these terms are well known in the art.

Abstract machines specify a process by which values are accessed and computation is done. They may be implemented directly in hardware. They may also be emulated in software. It is also possible for software to mimic the behaviour of an abstract machine without implementing the same underlying steps. A software emulation or software mimic would not depart from the spirit and scope of the present invention.

### BRIEF SUMMARY OF THE INVENTION

The invention covers the use of a structured language to describe or script business plans, and an accompanying system for interpreting plans written using this language and producing outputs which can include spreadsheets and charts. We use the term “plans” to include any business plan, project plan, forecast or other numerical activity which might typically be done with a spreadsheet.

The main existing approach to such tasks involves the use of spreadsheets.

Spreadsheets can be laborious to create, and it is easy to make mistakes, for example referencing the wrong range of rows in a formula. Spreadsheets present plans as a large table of numbers, and this can make the core of a plan hard to pick out.

The inventor realized that significant improvements would result from a system which addressed the weaknesses of spreadsheets.

The inventor devised a Plan Language that allows users to express plans in a text format by following the syntactic rules of the Plan Language. The Plan Language encodes typical natural ways of expressing plans, adding enough structure to allow for computer interpretation. The Plan Language is a Domain Specific Language which is designed to be both human readable and machine interpretable. Example statements might be “Rent: $500 per month” or “Overheads: 10% of Wages”.

A Plan Evaluation Engine (PEE) reads plans written using the Plan Language. The PEE takes a plan and runs a simulation of the plan, creating a spreadsheet (or other table-like data-structure) recording the effects of the plan. For example, a line of text in the plan such as “Rent: $500 per month” would correspond to a row of cells in a spreadsheet after the evaluation engine has run, one cell for each month if the columns are months.

The PEE uses a Grid-Valued Machine for computation. This is an abstract machine, like a Register Machine in processing a program (the user's plan) with a program stack and a data-storage model, but it differs from a Register Machine in that whereas Register Machine variables have a single value which can be changed, the Grid-Valued Machine variables have a row of values, which do not change. A Grid-Valued Machine is also like a spreadsheet, in that it stores numerical data in a grid, but unlike a spreadsheet in that, whereas a spreadsheet implicitly encodes a plan in the formulae held in individual cells, the Grid-Valued Machine uses a separate plan document.

In addition, the Plan Language includes ways to specify uncertainty. An example statement involving uncertainty might be “Sales: 10+−5 per month” which would correspond to a probability distribution over the number of sales, with mean 10 and a range from 5 to 15. The evaluation engine can simulate the effects of probability distributions, by running multiple simulations or otherwise.

A developer may use alternative ways of processing plans instead of a grid-valued abstract machine. This would still fall within the scope of this invention.

### BRIEF DESCRIPTION OF THE SEVERAL VIEWS OF THE DRAWING

FIG. 1 is an architectural view of the preferred embodiment of the invention. It shows the components involved in processing a user's plan. A user's plan (A) is written using the Plan Language (B), and read in by the PEE Parser Module (C) then processed by the PEE Evaluation Module (D), producing final outputs which can include spreadsheets and charts (E). The PEE uses the Plan Language (A) and a Grid-Valued Machine (F)—possibly implemented on standard hardware (G)—to produce the Output Grid (H).

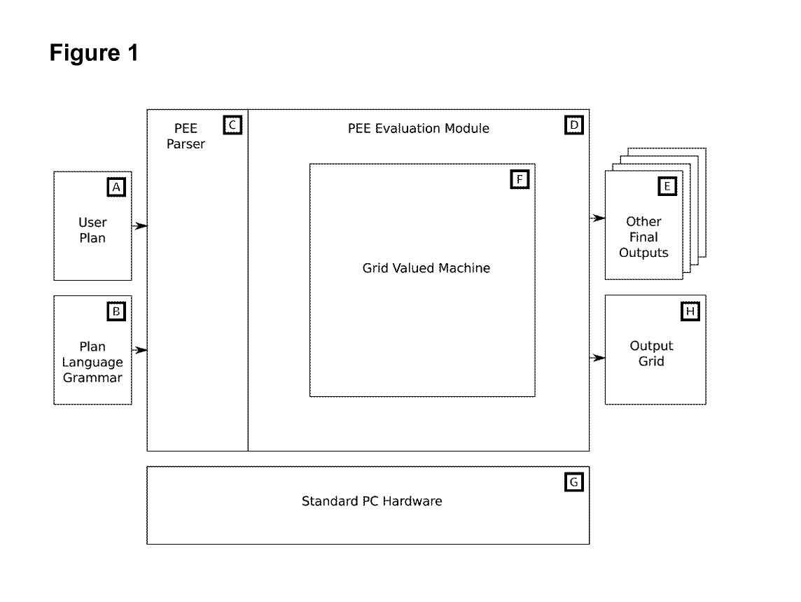

### DETAILED DESCRIPTION OF THE INVENTION

Best mode of carrying out the invention:

The invention is described in enabling detail by way of the preferred embodiment provided below.

The preferred embodiment of the Plan Language works as follows:
1. A plan consists of a series of statements, one per line, and is used to generate a 2 dimensional grid of output values (cells) which is the Output Grid.
2. Statements are either Row Statements or Output Statements.
3. A Row Statement (e.g. “Sales after month 6: $1000 per month”) specifies a variable or variables (e.g. “Sales”), an optional filter on when the statement applies (e.g. “after month 6”), and a formula (e.g. “$1000 per month”). Syntax markers allow both human & computer readers to distinguish the parts of a statement.
4. Where a Row Statement mentions a variable, this creates a row in the Output Grid for that variable.
5. Output Statements provide control over the columns in the Output Grid, the final outputs to be produced, the simulation parameters, and any other aspects that the system developer wishes to expose for user control within a plan. The system developer sets suitable defaults, making these statements optional in a plan.
6. The default behaviour for columns is that each column marks a time-step (e.g. one-column-per-month) and the grid covers a certain period (e.g. 3 years)—but that these settings can be changed with Output Statements or user preferences.
7. A formula can be simple (e.g. a single term such as a number), or complex (made up of multiple terms joined by operators, e.g. “2+7”).
8. Terms in a formula can include functions, variables, numerical values, standard arithmetical and logical operators, probability distributions, and other formulae.
9. The formula in a Row Statement is applied to all cells which match the variable & filter part of the statement. This differs from a formula in a conventional spreadsheet, which applies only to the cell it is in. This innovation simplifies the creation & editing of plans.
10. Formulae and filters can reference variables, either specifying the column to reference, or not, in which case the reference is evaluated for each relevant grid cell in the context of that cell's column. This differs from formulae in conventional spreadsheets, which explicitly reference specific cells. This innovation simplifies the creation & editing of plans.
11. The Plan Language includes non-technical ways of specifying some common distributions (e.g. “10+/−2” specifying the uniform distribution over the range 8 to 12). The use of probability distributions allows plans to represent uncertain quantities, and carry out stochastic analysis.

It will be apparent that the use of rows versus columns may be interchanged without changing the invention, and that other column markers may be used instead of time-steps

In the preferred embodiment, the Plan Language is fully specified using a formal grammar (which are well known in the art), and an example of such a grammar is set out in Sequence Listing 1.

The invention may be provided using a language which differs in both syntax and features without departing from the spirit and scope of the present invention.

The Plan Evaluation Engine (PEE) is a software system that takes a plan, written in the Plan Language, and evaluates it to produce the desired outputs.

The PEE has a Parser Module which uses computer interpretation techniques to extract the structure of the plan. This is known in the art as parsing. If a formal grammar was used to specify the Plan Language, then this can also be used, with suitable software, to parse it. This approach is well known in the art.

The PEE has an Evaluation Module. In the preferred embodiment, plans are evaluated using a Grid-Valued Machine, which is a form of abstract machine that works as follows:
1. An empty grid is created based on the plan. The grid rows correspond to variables, and the grid columns correspond to time-steps (or other column markers, as specified by the plan).
2. Each cell in the grid may contain data, typically a numerical value. Initially, each cell contains a flag indicating that the cell has yet to be evaluated.
3. A sub-component called the Evaluation Head moves across the grid, calculating values for each cell, once per cell. When the Evaluation Head is over a cell, then the current row and current column are the row and column of the cell.
4. At each cell, the Evaluation Head selects the appropriate formulae for that cell from the formulae specified by the user's plan. This selection examines the Row Statements, and picks those that match the current row based on the variable & filter parts of the Row Statements.
5. The evaluation head then calculates the output from those formulae, and stores the outputs in the cell.
6. Formulae may reference other cells in the grid.
7. Formulae may make use of the position of the evaluation head, so that the same formula generates different outputs for different cells.
8. a. The position of the evaluation head defines a default column for referencing other variables (for example, if the statement “Profit: 100—Costs” were evaluated in the “Profit” row, column 3, then the “Costs” term would reference the value for the “Costs” row, column 3).
8. b. The position of the evaluation head defines a row/column position for relative referencing (for example, the term “previous” in a formula indicating the same row, one column left).
9. Where a formula for cell A references another cell B, this causes the Evaluation Head to move to cell B, then calculate the value for cell B if it has not already been calculated, then return to cell A to complete that calculation using the value from cell B as specified by the formula for cell A.
10. When carrying out such nested calculations, the Evaluation Head uses a call stack to track it's position in the calculation. Call stacks are well known in computer science.
11. Cell-level circular references in formulae (where cell A depends on cell B which depends on cell A) cause loops, and lead to an error being outputted.
12. The Grid-Valued Machine halts when the Evaluation Head has evaluated each cell in the grid.

This grid-valued model for processing, where variables have multiple values (one per time-slice) that do not change once calculated, is a new alternative to the Register Machine model (which is well known in computer science), where variables have one value, which can be changed.

The resulting Output Grid can then be presented as a spreadsheet, or used to generate charts or other reports. The language can include ways to specify the desired outputs.

In the preferred embodiment, the components of the Grid-Valued Machine are implemented in software using a standard programming language & computer hardware.

One skilled in the art may use alternative ways of processing plans instead of a Grid-Valued Machine. This would still fall within the scope of this invention.

Where a plan contains stochastic statements (that is, some of the rules use probability distributions), the plan is evaluated using a Monte Carlo sampling-based approach (which may be applied to the whole plan or just to the affected cells, noting that a formula which references a distribution will itself output a distribution). The term Monte Carlo is well known in probability theory. A Monte Carlo approach is particularly flexible, and allows the handling of complex rules involving conditional statements.

In the preferred embodiment, a Monte Carlo approach is applied at the level of the whole plan by running multiple Grid Valued Machines, where the Evaluation Head calculates a value from a distribution by sampling. The cells from the Grid Outputs are then combined to give an output grid where the cells may contain distributions.

It will be apparent to one with skill in the art that the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A language (a set of syntax rules and keywords) for specifying business plans, project plans, forecasting or other numerical activity which might typically be done with a spreadsheet, characterized by being a human readable specification of the plan which is suitable for machine interpretation.

2. The language of claim 1 where statements in the language specify (a) variables or a grouping of variables, and (b) rules to be applied to those variables (which can include formulae and conditional statements), and optionally (c) filters restricting the range of a rule's application (which can also include formulae and conditional statements).

3. The language of claim 2 where one model for the semantics of plans written in the language is to link a plan with a two-dimensional grid of values (similar to spreadsheets) with variables corresponding to rows in the grid, and where the columns of the grid may be set by the plan, or given by a default time-step scheme, or set by user input.

4. The language of claim 3 where a statement in the language can select a portion of the grid (selecting rows by the variable or group of variables mentioned, and selecting within those rows if a filter is specified), and hence a statement can apply a formula to all the cells within that portion of the grid.

5. The language of claim 4, where variable references within a formula can reference different grid cells based on the position of a cell in the grid (so that the evaluation of a statement can produce different values for different grid cells), using the column of the cell being calculated as a default column for referencing other rows, & the row/column of the cell being calculated as the reference row/column for relative positioning.

6. The use of computer interpretation techniques to parse plans specified using the language of claim 5, converting them into a data-structure suitable for machine processing.

7. A system for evaluating plans created using the language of claim 5 which uses a memory model with a 2 dimensional grid of values, where the value for each grid cell is calculated once.

8. The system of claim 7 where the calculation for each grid cell uses formulae specified by statements in the plan that match that grid cell, based on it's row name, column or other filtering criteria.

9. The system of claim 8 where the calculations can reference other grid cells, and such references can be relative to the position of the cell being calculated, so that the same formula can produce a different output in different cells.

10. The language of claim 5 where the language includes keywords and formulas for expressing stochastic elements (i.e. uncertainty), by specifying probability distributions.

11. The evaluation of plans written in the language of claim 10 according to the mathematics of the probability distributions involved, including using a Monte Carlo approach of running a plan multiple times with sampling to convert distributions into fixed values within each run, then aggregating the outputs to produce a stochastic output.
